(19) United States
(12) Patent Application Publication
(10) Pub. No.: US 2004/0121070 A1
(43) Pub. Date: Jun. 24, 2004

(54) Connect diamond powders by cycloaddition reactions

(76) Inventors: Jishou Xu, Bloomington, IN (US); Edmond Bowden, Raleigh, NC (US)

Correspondence Address: JUSHOU XU, 15 HEARTHSTONE, IRVINE, CA, 92606, US

(21) Appl. No.: 10/328,410

(22) Filed: Dec. 21, 2002

(51) Int. Cl. B05D 1/12; B05D 7/00

(52) U.S. Cl. 427/212; 427/180

(57) ABSTRACT

The invention sets forth a method to connect diamond powders with other diamond powders or to connect diamond powders with substrates by cycloaddition reactions. The diamond powders are pretreated to desorb non-carbon surface atoms. The cycloaddition reactions are between clean diamond surfaces and C—C double bonds in the cross-linking molecules, which are either conjugated or not. The reactions are performed at temperatures <200 Celsius degree. The cross-linking molecules are covalently bonded to diamond powders through C—C single bonds. The method produces diamond structures with big sizes. The diamond structures produced by the method can be chemically stable. The diamond structures produced by connecting diamond powders are porous.

### REFERENCES CITED

| U.S. Pat. Nos. | |
|---|---|
| 5534314 | Wadley |
| 5593783 | Miller |
| 6372002 | D'Evelyn |
| 6406776 | D'Evelyn |
| 5912217 | Sumina |
| 6350389 | Fujishima |
| 5885541 | Bates |

### Other References

Cycloaddition reactions on diamond surface:

1. Hamers, R. J.; et al “Cycloaddition Chemistry of Organic Molecules with Semiconductor Surfaces” Acc. Chem. Res., 2000, 33, 617.

2. Wang G., Bent S., “Functionalization of Diamond(100) by Diels-Alder Chemistry” J. Am. Chem. Soc., 2000, 122, 744.

3. Hovis, J.; Coulter, S.; Hamers, R.; D'Evelyn, M.; Russell, J.; Butler, J. “Cycloaddition Chemistry at Surfaces: Reaction of Alkenes with the Diamond (001)-2×1 Surface”J. Am. Chem. Soc., 2000, 122, 732.

4. Fitzgerald, D. R.; Doren, D. J. “Functionalization of Diamond(100) by Cycloaddition of Butadiene: First-Principles Theory” J. Am. Chem. Soc., 2000, 122, 12334.

5. Russell, J. N.; et al “π Bond versus Radical Character of Diamond (100)-2×1 Surface” Mater. Chem. Phys., 2001, 72, 147.

Desorption of non-carbon surface atoms on diamond surface

6. D'Evelyn, M. P. “Chapter 4: Surface Properties of Diamond” in The Properties of Natural and Synthetic Diamond, Ed., Field, J. E.; Academic Press: London, 1992.

7. Schulberg, M. T.; Fox, C. A.; Kubiak, G. D.; Stulen, R. H. “Hydrogen Desorption from Chemical Vapor Deposited Diamond Films” J. Appl. Phys., 1995, 77, 3484.

8. Thoms, B. D.; Pehrsson, P. E.; Butlers, J. E. “Vibrational Study of the Adsorption and Desorption of Hydrogen on Polycrystalline Diamond”” J. Appl. Phys., 1994, 75, 804.

9. Hadenfeldt, S.; Benndorf, C. “Adsorption of Fluorine and Chlorine on the Diamond (100) Surface” Surf. Sci., 1998, 402, 227.

10. Struck, L. M.; D'Evelyn, M. P. “Interaction of Hydrogen and Water with Diamond (100): Infrared Spectroscopy” J. Vac. Sci. Tech., 1993, 11, 1992.

Porous diamond & diamond ceramics

11. Semchinova, O.; Uffmann, D.; Neff, H.; Smimov, E. P. “Growth, Preparation and Surface Modification of Microcrystalline Diamond Powder for the Synthesis of Diamond Ceramics” J. Eur. Ceram. Soc., 1996, 16, 753.

12. Mammana, V.; et al “Diamond Membranes with Controlled Porosity”, Diamond Related Materials, 1997, 6, 1824.

### BACKGROUND OF INVENTION

The invention relates to connecting diamond powders to diamond powders, or connecting diamond powders to substrates. The purpose of connecting diamond powders is to construct three-dimensional diamond structures with big sizes and to construct thick diamond coatings. The connection of small diamond powders into an assembly of diamond powders also produces porous diamond structures.

The high resistance of diamond to chemical, thermal, electrical, and optical stress makes it a promising material for technically demanding applications. Diamond materials are limited in size. Another limitation for diamond materials is that almost all diamond materials are non-porous. For many applications from electronics to bioengineering (e.g., gas separation, water purification, liquid chromatography, ultra-filtration, and oil decontamination), it is interesting to obtain porous structures (e.g., porous cylinder, porous membrane, and porous particle) with large effective areas and controlled pore sizes. It is desirable for porous structures to have high stability under various chemical environments (e.g., strong acid, strong base, reductant, oxidant, and organic solvents). Diamond is a promising material to construct porous structures with high chemical stability because of its chemical inertness.

For the materials formed by connecting small powders, the connection among small powders usually limits the overall chemical resistance of the materials. Considering the fact that diamond has chemical inertness, the connection for diamond powders is best to have high resistance to chemical stress, so that the overall chemical resistance of the diamond structures will not be deteriorated by the connection substantially.

The invention sets forth a method to connect diamond powders by chemical reactions between the surface sites on diamond powders and cross-linking molecules. Diamond powders will be connected to the cross-linking molecules through covalent surface bonds formed by cycloaddition reactions. The cycloaddition reaction forms two covalent surface bonds between a diamond powder and a cross-linking molecule. One or both of these two surface bonds will be C—C single bonds. With one end of the cross-linking molecules linked onto a diamond powder, the other end of the cross-linking molecules is linked to another diamond powders or a substrate. In this way, diamond powders are connected with each other through the cross-linking molecules or diamond powders are connected to a substrate through the cross-linking molecules. The cycloaddition reactions will be performed at temperatures <200 Celsius degrees. Generally speaking, the invention sets forth a “cold-welding” technique for diamond powders.

In particular, the invention sets forth a method to produce porous diamond structures. By connecting diamond powders at low temperatures, there will be no shrinking or merging of diamond powders. After the diamond powders have been connected, the shape and volume of the diamond powders will not be changed and the void space among diamond powders is preserved. The diamond structures produced in such a way are with significant porosity.

The connection through C—C single bonds is advantageous in chemical stability because C—C single bonds could be the most stable among chemical bonds for organic molecules. In this way, the chemical stability of both the diamond powders and the connection among diamond powders will outperform almost all organic compounds and biochemcials.

### DESCRIPTION OF THE RELATED ART

Diamond has been synthesized by a variety of processes. Diamond can be produced from other carbon materials by phase change. Diamond can also be produced by steadily accreting new atomic carbon on the surface of some small seed crystal or substrate. For example, diamond powders are produced under high temperature and high pressure. Diamond powders produced under high pressure and high temperature are small in size. Diamond films are prepared by chemical vapor deposition (CVD). The generic synthesis processes used for CVD of diamond films are that the growth rate is too slow and the growth conditions are too harsh (e.g., substrate temperature >800 Celsius degree). Diamond films produced by CVD can be large in area but are usually thin.

It is well accepted in material engineering to form materials with large sizes by connecting small powders (e.g., the preparation of ceramics from fine powders and the formation of thick coating by sputtering). The “connecting” is most commonly fulfilled by heating. The “connecting” can be also fulfilled by chemical reactions with cross-linking molecules. Cross-linking molecules link two or more small powders together through chemical bonds. Connecting small diamond powders into diamond structures by heating is not feasible. Connecting small diamond powders into diamond structures by chemical reactions is still a technical task to be solved.

U.S. Pat. Nos. 6,406,776 and 6,372,002 proposed a method to connect functionalized diamond powders with substrates by chemical reactions. The diamond powders were connected to substrates through covalent surface bonds. The reactions are nucleophilic substitution reactions. Many of the surface bonds formed by the suggested nucleophilic substitution reactions (e.g., ester bonds) have limited chemical stability. Most importantly, the connection of diamond powders to diamond powders is not proposed.

Cycloaddition reactions are a family of reactions for unsaturated organic compounds and are well-studied in organic chemistry. For example, a C—C-double bond can react with a conjugated diene structure (i.e., [4+2] cycloaddition reactions) to form cyclohexene. Cycloaddition reactions can occur spontaneously under mild conditions (e.g., room temperature without the assistance of solvent, pH buffer, or catalyst). Conventionally, cycloaddition reactions form C—C single bonds. Cycloaddition reactions at clean diamond surfaces have been reported. The surfaces of diamond powders typically comprise surface carbon atoms covalently capped by oxygen functionalities and hydrogen atoms. When diamond powders are heated under temperatures >1000 Celsius degree or activated by some other energetic processes, the oxygen functionalities or hydrogen atoms are desorbed. The clean diamond surfaces are composed of carbon atoms without any non-carbon surface atoms. The surface carbon atoms on diamond thus have dangling bonds. It was proposed that the neighboring carbon dangling bonds would undergo reconstruction to form surface C—C double bonds. Either the surface C—C double bonds or these carbon dangling bonds serve as surface sites for cycloaddition reactions. It has been reported that these surface sites are more active to cycloaddition reactions than C—C double bonds in alkenes. Connecting diamond powders by cycloaddition reactions is advantageous in: i) the connecting can be performed under mild conditions; ii) the connecting can be performed without any solvent, pH buffer, or catalyst, which simplifies process control and minimizes the production of waste; and iii) the C—C single bonds formed are chemically stable.

The preparation of porous diamond is still a technical task to be solved. Diamond powders prepared under high pressure and high temperature are rarely porous. Preparation of porous diamond by chemical vapor deposition (CVD) has been reported. The disadvantage for such a process is that: CVD of diamond is time consuming, and the porosity and pore structure is difficult to control. U.S. Pat. No. 5,885,541 proposed to prepare porous bulky diamond by connecting diamond powders. The void space among the diamond powders makes the bulky material porous. By controlling the size and the shape of the diamond particles used to form the mold, the method provides a process by which large pieces of diamond can be fabricated with controlled porosity. Unfortunately, the connection of the diamond particles was fulfilled by a CVD process. The disadvantages for connecting diamond powders by CVD include: i) CVD processes are usually carried out under harsh conditions (e.g., substrate temperature up to 800 Celsius degree); ii) CVD is feasible to form diamond on external surfaces rather than to form diamond inside a three dimensional matrix; and iii) the diamond growth may fill a significant fraction of the void space in the porous structure or even block the path for mass flow.

Instead of the energetic CVD processes, cycloaddition reactions under mild conditions can be used to connect the molded diamond powders. The diamond powders will be connected through C—C single bonds. Though C—C single bond is not as stable as diamond, it is one of the most stable chemical bonds. Connecting the molded diamond powders into porous diamond structures by using cycloaddition reactions will be advantageous in: i) the process will be at relatively low temperature (e.g., room temperature); ii) as long as the surface sites are not spatially excluded from the reagents, the cycloaddition reactions can occur at sites located on external surface, inner surface, or pore walls inside a three dimensional matrix; and iii) the porosity of the molded diamond powders is preserved because the cross-linking molecules attached onto diamond powders will nearly occupy no space.

The cycloaddition reactions discussed above are also feasible at silicon surfaces with all non-silicon surface atoms desorbed. The cycloaddition reaction can be used to connect silicon powders or to connect silicon powders to substrates.

### SUMMARY OF THE INVENTION

The invention sets forth a method to connect diamond powders to diamond powders, or to connect diamond powders to substrates by using cycloaddition reactions. The cycloaddition reactions are between organic cross-linking molecules and diamond surfaces with their non-carbon surface atoms fully or partially desorbed. The organic cross-linking molecules contain double bonds or conjugated double bonds. Each double bond contains at least one unsaturated carbon atoms. The cycloaddition reaction can be, for example, but is not limited to, [4+2] cycloaddition reactions with an organic molecule containing diene structure. The covalent surface bonds formed by cycloaddition reactions can be, but are not limited to, C—C, C—O, C—N, and C—Si single bonds, more preferable C—C single bonds. The substrate material can be, but is not limited to, carbon materials, silicon, silica, and polymers. Diamond powders comprise diamond powders that occur naturally in nature and diamond powders that are manufactured. The number of diamond powders is not limited. Diamond powders can be, but not limited to, diamond powders with a size from a few micro-meters to a few nano-meters.

Exemplary processes for connecting diamond powders will now be discussed:

STEP 1: The process begins with diamond powders that are commercially available, whose surface carbon atoms are typically capped by oxygen functionalities or hydrogen atoms. The diamond surfaces can be alternatively capped by hydrogen only. The hydrogenation step comprises heating the diamond powders in a hydrogen atmosphere at elevated temperature. The temperature can be, for example, but not limited to, 700-900 Celsius degrees. The hydrogen atmosphere can contain hydrogen with one or more inert gases. The inert gas can be, for example, but not limited to, helium. The hydrogen atmosphere can be continuously flowing through the reactor during the hydrogenation process. After the hydrogenation process, the diamond powders will be cooled down to room temperature in the hydrogen atmosphere. The hydrogenation step is alternatively performed by subjecting diamond powders to a hydrogen plasma or hydrogen atoms.

STEP 2: To have the cycloaddition reactions to occur, the non-carbon atoms on diamond surface must be partially or fully desorbed. Diamond powders will be pretreated to produce surface sites that will undergo cycloaddition reactions. The pretreatment of diamond powder can be, for example, but is not limited to, heating the diamond powders under high temperatures. The diamond powders can be as-received diamond powders or hydrogenated diamond powders produced by STEP 1. The pretreatment of diamond powders can be, for example, but not limited to, heating the diamond powders under high temperatures. The temperature can be about, for example, but not limited to, 1000 Celsius degrees. The pretreatment will be performed in vacuum or in an inert gas. The inert gas can be, for example, but not limited to, helium. The pretreatment desorbs some or all non-carbon atoms on the diamond surface. The reactor will be cooled down to room temperature with the reactor being flown with the inert gas or being kept in vacuum.

The desorption of surface hydrogen atoms on hydrogenated diamond powders is alternatively performed with the presence of a catalytic gas. The catalytic gas can be, for example, but not limited to, chlorine. The gas atmosphere can contain the catalytic gas with an inert gas. The inert gas can be, for example, but not limited to, helium. The catalytic gas will react with surface C—H bonds and the hydrogen atoms on diamond surfaces are abstracted away. The temperature can be at, for example, but not limited to, 500 Celsius degree. Alternatively, the temperature can be cycling between 200 and 500 Celsius degree. The gas atmosphere can be continuously flowing through the reactor. At the end of the process, the reactor will be purged with a gas atmosphere containing only the inert gas at about 500 Celsius degree. The atoms of the catalytic gas will not be attached onto the diamond surface because the diamond surface terminated by the atoms of the catalytic gas is unstable at about 500 Celsius degrees. The reactor will be cooled down to room temperature with a gas atmosphere containing only the inert gas.

STEP 3A: to connect diamond powders to substrate

The diamond powders produced by STEP 2 are exposed to a substrate pre-functionalized with organic moieties. These organic moieties contain functionality to undergo cycloaddition reactions with diamond powders produced in STEP 2. The functionality can be, for example, but not limited to, diene groups. The diamond powders are thus connected to the organic moieties on the substrates through covalent surface bonds. The covalent surface bonds can be, for example, but not limited to, C—C, C—O, or C—N single bonds, more preferable C—C single bonds. The substrates can be, for example, but not limited to, silicon, diamond, polymers, silica, or metals.

The substrate used in STEP 3A can be previously patterned. The organic moieties can be immobilized on, for example, but not limited to, a planar surface, outer wall of tubes, or inner wall of tubes. The organic moieties can be alternatively immobilized on the pore walls inside a porous structure.

STEP 3B: to functionalize diamond powders for connection

The diamond powders produced by STEP 2 are exposed to bi-functional cross-linking molecules. The bi-functional cross-linking molecules can be in a state of, for example, but are not limited to, pure liquid or solution in an inert solvent. The inert solvent can be, for example, but not limited to, hexane or cyclohexane. For a bi-functional cross-linking molecule, both functionalities can undergo cycloaddition reactions with the diamond powders produced in STEP 2. Both functionalities can be, for example, but are not limited to, diene group. After the bi-functional cross-linking molecules covalently bonded to diamond powders, some or all of these bi-functional cross-linking molecules are in a state that, for each bi-functional cross-linking molecule, only one functionality is reacted and the other functionality remains un-reacted. The diamond powders are thus attached with bi-functional cross-linking molecules through covalent surface bonds. The covalent surface bonds can be, for example, but not limited to, C—C, C—O, or C—N single bonds, more preferable C—C single bonds. After STEP 3B, the diamond powders produced by STEP 2 are functionalized with functionalities that can undergo cycloaddition reactions with the diamond powders produced by STEP 2.

For a bi-functional cross-linking molecules, the two functionalities can be on the opposite side of rings, for example, but not limited to, 1,2,4,5-tetramethylene-octahydro-pentalene or 1,2,4,5-tetramethylene-cyclohexane. After one functionality of the bi-functional cross-linking molecule has undergone cycloaddition reaction with and covalently bonded onto a diamond powder, the other functionality of that bi-functional cross-linking molecule will point away from that diamond powder. The other functionality of that bi-functional cross-linking molecule is thus not in the distance to undergo cycloaddition reaction with the surface sites on that diamond powder.

Alternatively, there will be a large number of bi-functional cross-linking molecules at high concentration in the reactor (e.g., pure liquid of the bi-functional cross-linking molecule). There are always many bi-functional cross-linking molecules surrounding each diamond powder and competing for the surface sites on diamond powders that are active to cycloaddition reactions. Because bi-functional cross-linking molecules are highly over-amounted to the reactive surface sites on diamond powders, the surface sites on diamond powders are completely reacted in a short time. As a result, many bi-functional cross-linking molecules are not reacted, some bi-functional cross-linking molecules are with one functionality of each bi-functional cross-linking molecule reacted, and some bi-functional cross-linking molecules are with both functionalities of each bi-functional cross-linking molecule reacted. Some of the bi-functional cross-linking molecules that have been covalently immobilized on diamond powders are in a state that, for a bi-functional cross-linking molecule, only one functionality is reacted and the other functionality remains un-reacted.

When it is necessary to avoid connecting diamond powders during this procedure, there will be only a small number of diamond powders in the reactor. A diamond powder will collide with bi-functional cross linking molecule at a much higher frequency than with another diamond powder. The surface sites active for cycloaddition reactions on a diamond powder will be reacted completely by the bi-functional cross-linking molecules in the solution before it hardly have any chance to react with the bi-functional cross-linking molecules that have already been immobilized on another diamond powder. These diamond powders will not be covalently bonded to another diamond powder after STEP 3B.

STEP 3C: to connect diamond powders

The diamond powders produced by STEP 2 are exposed to bi-functional cross-linking molecules. The bi-functional cross-linking molecules can be in a state of, for example, but are not limited to, pure liquid or solution in an inert solvent. The inert solvent can be, for example, but not limited to, hexane or cyclohexane. For a bi-functional cross-linking molecule, both functionalities can undergo cycloaddition reactions with the diamond powders produced in STEP 2. Both functionalities can be, for example, but are not limited to, diene group. For a bi-functional cross-linking molecules, the two functionalities can be on the opposite side of rings, for example, but not limited to, 1,2,4,5-tetramethylene-octahydro-pentalene or 1,2,4,5-tetramethylene-cyclohexane. After one functionality of a bi-functional cross-linking molecule has undergone cycloaddition reaction and covalently immobilized on a diamond powder, the other functionality of that bi-functional cross-linking molecule will point away from that diamond powder. The other functionality of that bi-functional cross-linking molecule is thus not in the distance to undergo cycloaddition reaction with the surface sites on that diamond powder. The other functionality of that bi-functional cross-linking molecule can react with the surface sites on another diamond powder produced by STEP 2.

There will be a large number of diamond powder produced by STEP 2 in the reactor, a diamond powder will have a high frequency to collide with other diamond powders. If a diamond powder has been attached with one or more bi-functional cross-linking molecules, it may collide with other diamond powders with surface sites that will undergo cycloaddition reaction with the bi-functional cross-linking molecules. The un-reacted functionalities that are immobilized on that diamond powder will undergo cycloaddition reactions with one or more other diamond powders that that diamond powder collides with. Two or more diamond powders are thus connected together by bi-functional cross-linking molecules. Alternatively, two or more diamond powders are in contact with each other. At or near the contact area between two diamond powders, after one functionality of a bi-functional cross-linking molecule has reacted with a diamond powder, the other functionality of that bi-functional cross-linking molecule may react with the surface sites on another diamond powder. If a diamond powder is in contact with several other diamond powders, that diamond powder may be connected to all the diamond powders in contact with it through bi-functional cross-linking molecules. Cross-linking molecules are bonded to diamond powders through covalent surface bonds. The covalent surface bonds can be, for example, but not limited to, C—C, C—O, or C—N single bonds, more preferable C—C single bonds. For a surface site on a diamond powder that can undergo cycloaddition reaction, there will be a competition for that surface site to react with a bi-functional cross-linking molecule (which is in solution) with two functionalities being reactive and to react with a bi-functional cross-linking molecule (which is immobilized on another diamond powder) with one functionality reactive. To decrease the rate of the reaction between surface sites on diamond powders and bi-functional cross-linking molecules (which are in solution) with two functionalities reacive, the concentration of the bi-functional cross-linking molecules will be low. The diamond powders can be exposed to the bi-functional cross-linking molecules for a long time. To cross-link a large number of diamond powders into desired shapes with macro-sizes, the diamond powders used in STEP 3D can be, for example, but not limited to, densely pre-packed or pressed mechanically by high pressure.

STEP 3D: connect diamond powders

The diamond powders produced by STEP 2 are exposed to bi-functional cross-linking molecules. The bi-functional cross-linking molecules can be in a state of, for example, but are not limited to, pure liquid or solution in an inert solvent. The inert solvent can be, for example, but not limited to, hexane or cyclohexane. Both functionalities of the bi-functional cross-linking molecule can undergo cycloaddition reactions with diamond powders produced by STEP 2. The functionalities of the bi-functional cross-linking molecules can be, for example, but not limited to, diene groups. The two functionalities of a bi-functional cross-linking molecule can be, for example, but not limited to, at two ends of alkyl chains. There are a large number of diamond powders in the reactor. The diamond powders used in STEP 3D can be, for example, but not limited to, densely pre-packed or pressed mechanically by high pressure into desired shapes and sizes. For a bi-functional cross-linking molecule, the two functionalities can be linked to the same diamond powder, linked to two diamond powders, or with only one of these two functionalities reacted. There are a large number of bi-functional cross-linking molecules attached onto each diamond powder. For two diamond powders are in contact with each other, they can be cross-linked by one or more bi-functional cross-linking molecules. A diamond powder can be linked to several or all other diamond powders in contact with it. Diamond powders are thus linked together with covalent surface bonds. The covalent surface bonds can be, for example, but not limited to, C—C, C—O, or C—N single bonds, more preferable C—C single bonds.

STEP 3E: prepare superficially porous diamond powders

The invention sets forth a method to prepare diamond powders with a solid core of diamond powder (referred as coarse diamond powder below) and a superficially porous external layer of diamond powders with sizes much smaller than the coarse diamond powders (referred as fine diamond powders below). For example, the coarse diamond powders can be of a size of a few micron while the fine diamond powders are of a size less than 200 nano-meters. Both the coarse diamond powders and the fine diamond powders will be pretreated as in STEP 1 and STEP 2. The coarse diamond powders produced by STEP 2 are exposed to the bi-functional cross-linking molecules as in STEP 3B. After the treatment, the coarse diamond powders are attached with bi-functional cross-linking molecules. Some or all of the bi-functional cross-linking molecules that have immobilized on the coarse diamond powders are in a state that, for a bi-functional cross-linking molecule covalently bonded to a coarse diamond powder, only one functionality has been reacted and the other functionality remains un-reacted. The coarse diamond powders will be then exposed to the fine diamond powders as in STEP 2A. A layer of fine diamond powders will be attached onto the external surface of the coarse diamond powders (the resulted diamond powder is referred as composite diamond powder below).

After a layer of fine diamond powders have been immobilized on the external surface of a coarse diamond powder, for these fine diamond powders, only the surface sites on the side facing the coarse diamond powder are reacted. The surface sites on sides that are not in contact with the coarse diamond powder remain un-reacted and can undergo cycloaddition reactions with bi-functional cross-linking molecules. The composite diamond powders will be then exposed to bi-functional cross-linking molecules as in STEP 3B. Bi-functional cross-linking molecules will react with and be covalently bonded to the fine diamond powders that have been immobilized on the coarse diamond powders. During exposing to the bi-functional cross-linking molecules, if two fine diamond powders attached on the same coarse diamond powder are in contact with each other, they may be cross-linked by the bi-functional cross-linking molecules. After exposing to the bi-functional cross-linking molecules, the fine diamond powder that have been immobilized on the same coarse diamond powder may be cross-linked into a two dimensional network. The composite diamond powders will be then again exposed to the fine diamond powders as in STEP 2A. The composite diamond powders can undergo multiple cycles of exposing to bi-functional cross-linking molecules as in STEP 3B followed by exposing to the fine diamond powders as in STEP 3A.

The first layer of fine diamond powders can be alternatively attached onto coarse powders that are made of materials other than diamond as in STEP 3A. The coarse particles can be made of, for example, but not limited to, silicon, silica, metals, or polymers. The coarse powders have been pre-functionalized with organic moieties that can undergo cycloaddition reactions with the diamond powders produced by STEP 2.

STEP 4A: The product of STEP 3A can be performed with multiple cycles of exposing to bi-functional cross-linking molecules followed by exposing to diamond powders produced by STEP 2 as in STEP 3E. There are multiple layers of diamond powders attached onto the substrate after STEP 4A. A diamond powder that is immobilized on the substrate may be linked with several or all other diamond powders in contact with that diamond powder through covalent surface bonds.

STEP 4B: Diamond powders modified with organic groups can be sintered under high pressure and at elevated temperatures. The organic groups are covalently bonded to the diamond powders through C—C single bonds. Each organic group contains one or more C—C double bonds. Alternatively, each organic group contains one or more functionalities that are thermally unstable. The functionalities can be, but not limited to, halide atoms or hydroxyl groups. For each organic group, there will be one or more C—C double bonds formed by heating. Under high temperature, the C—C double bonds will undergo cycloaddition reactions. Some of the C—C double bonds attached on a diamond powder will undergo cycloaddition reaction with C—C double bonds that are attached on other diamond powders. The organic molecules are cross-linked, the organic molecules are covalently bonded to diamond powders. The diamond powders are cross-linked.

STEP 5A: The substrate of the product from STEP 4A can be etched away to form free-standing diamond structure. The coarse particles for the composite particles produced in STEP 3E with coarse particles of materials other than diamond can be etched away. The etching process can be performed in, but not limited to, concentrated sodium hydroxide, hydrochloric acid, or hydrofluoric acid.

STEP 5B: The products of STEP 3A-E, STEP 4A, and STEP 5A are then further modified. The modification can be occurred at both the cross-linking molecules and the surfaces of diamond powders. The modification reaction can be, but not limited to, addition reaction with the unsaturated carbon atoms or substitution reactions with saturated carbon atoms. The products can undergo addition reaction with both the unsaturated double bonds in the cross-linking molecules and unsaturated carbon atoms on the surfaces of diamond powders. The addition reaction can be performed with, but not limited to, hydrogen, chlorine, or HCl gas.

STEP 6A: The products of STEP 4A, STEP 5A and STEP 3E are covered with an external layer of diamond film produced by CVD.

Instead of diamond powders, silicon powders with some or all non-silicon surface atoms desorbed can be performed with STEP 3A-E and STEP 4A.

We claim:

1. A method of connecting diamond powders to a substrate, the method comprising: exposing one or more diamond powders to one substrate. The diamond powders are with some or all non-carbon surface atoms desorbed. The substrate has been pre-functionalized with one or more organic molecules. Some or all of the organic molecules have functionality to undergo cycloaddition reaction with the diamond powders. The functionality contains one C—C double bond with or without another double bond conjugated with the C—C double bond. At least one of the surface bonds formed between a functionality and a diamond powder is C—C single bond.

2. A method of functionalizing diamond powders, the method comprising: exposing one or more diamond powders to one or more bi-functional cross-linking molecules. The diamond powders are with some or all non-carbon surface atoms desorbed. For each bi-functional cross-linking molecule, both functionalities can undergo cycloaddition reaction with the diamond powders. Both functionalities contain one C—C double bond with or without another double bond conjugated with the C—C double bond. At least one of the two surface bonds formed between a functionality and a diamond powder is C—C single bond. One or more bi-functional cross-linking molecules covalently bonded to a diamond powder are in a state that, for a bi-functional cross-linking molecule, only one of the two functionalities is reacted and the other functionality remains un-reacted.

3. A method of connecting diamond powders, the method comprising: exposing two or more diamond powders to one or more bi-functional cross-linking molecules. The diamond powders are with some or all non-carbon surface atoms desorbed. For each bi-functional cross-linking molecule, both functionalities can undergo cycloaddition reaction with the diamond powders. Both functionalities contain one C—C double bond with or without another double bond conjugated with the C—C double bond. At least one of the two surface bonds formed between a functionality and a diamond powder is C—C single bond. One or more bi-functional cross-linking molecules covalently bonded to a diamond powder are in a state that, for a bi-functional cross-linking molecule, the two functionalities are covalently bonded to two different diamond powders.

4. The process of claim 1, wherein the substrate is pre-patterned.

5. The process of claim 2, wherein the bi-functional cross-linking molecule is selected from a group of molecules whose molecular structure renders steric restriction between the two functionalities. After one of the two functionalities has reacted with a diamond powders, the bi-functional cross-linking molecule is connected to the diamond powder through a four-membered or six-membered cyclic structure with two covalent surface bonds. Because of the steric restriction between the reacted functionality and the un-reacted functionality, the un-reacted functionality of that bi-functional cross-linking molecule is kept away from the surface of that diamond powder and can not undergo cycloaddition reaction with that diamond powder.

6. The process of claim 2, wherein one or more diamond powders are exposed to a large number of bi-functional cross-linking molecules at a high concentration. There are always many bi-functional cross-linking molecules surrounding each diamond powder and competing for the reactive sites on the diamond powders. After all reactive sites on the diamond powders have been reacted, some of the bi-functional cross-linking molecules that have been covalently bonded onto diamond powders are in a state that, for a bi-functional cross-linking molecule, both of the two functionalities are reacted. One or more of the bi-functional cross-linking molecules that have been covalently bonded to a diamond powder are in a state that, for a bi-functional cross-linking molecule, only one of the two functionalities is reacted and the other functionality remains un-reacted.

7. The process of claim 3, wherein the bi-functional cross-linking molecule is selected from a group of molecules whose molecular structure renders steric restriction between the two functionalities. After one of the two functionalities has reacted with a diamond powders, the bi-functional cross-linking molecule is connected to the diamond powder through a four-membered or six-membered cyclic structure with two covalent surface bonds. Because of the steric restriction between the reacted functionality and the un-reacted functionality, the un-reacted functionality of that bi-functional cross-linking molecule is kept away from the surface of that diamond powder and can not undergo cycloaddition reaction with that diamond powder. The un-reacted functionality of that bi-functional cross-linking molecule can react with the surface sites on another diamond powder.

8. The process of claim 3, wherein said a large number of diamond powders are pre-packed or mechanically pressed into desired shape and size. A diamond powder in the assembly of diamond powders is in contact with one or more other diamond powders.

9. A method of coating a top layer of diamond powders on a substrate, the method comprising: two or more cycles of a process that comprises the process of claim 1 followed by the process of claim 2.

10. The process of claim 9, wherein the substrate is powders made of materials other than diamond. The powders used as substrate are with sizes much bigger than the sizes of the diamond powders to be coated onto the substrate.

11. The process of claim 9, wherein the substrate is diamond powders. The diamond powders used as substrate are with sizes bigger than that of the diamond powders to be coated onto the substrate. The diamond powders used as substrate are with some or all non-carbon surface atoms desorbed and are functionalized by the process of claim 2.

12. The product of the process of claim 1

13. The product of the process of claim 2

14. The product of the process of claim 3

15. The product of the process of claim 8

16. The product of the process of claim 9

17. The product of the process of claim 9, wherein the substrate is powders made of materials other than diamond. The powders used as substrate are with sizes much bigger than the sizes of the diamond powders to be coated onto the substrate.

18. The product of the process of claim 9, wherein the substrate is diamond powders. The diamond powders used as substrate are with sizes bigger than that of the diamond powders to be coated onto the substrate. The diamond powders used as substrate are with some or all non-carbon surface atoms desorbed and are functionalized by the process of claim 2.

19. The product of claim 9, wherein the substrate is etched away.

20. A method of desorbing some or all non-carbon surface atoms on diamond powders, the method comprising: diamond powders with partially or fully hydrogenated surface. The surface hydrogen atoms are desorbed with the catalysis of chlorine. Chlorine molecules are activated by heating and become chlorine atoms. Chlorine gas will remove the surface hydrogen atoms by an abstraction reaction. The chlorine atoms will not be attached onto diamond surfaces because chlorinated diamond surface is unstable under the temperatures applied.

21. A method of connecting diamond powders, the method comprising: a large number of diamond powders being sintered under high pressure and at elevated temperatures. The diamond powders are pre-packed or mechanically pressed into desired shape and size. A diamond powder in the assembly of diamond powders is in contact with one or more other diamond powders. The diamond powders have been pre-functionalized with organic molecules. The organic molecules are covalently bonded to the diamond powders through C—C single bonds. Each organic molecule contains one or more C—C double bonds, or forms one or more C—C double bonds by heating. The isolated C—C double bonds or conjugated C—C double bonds can undergo cycloaddition reactions at elevated temperatures. Organic molecules attached on a diamond powder are linked to organic molecules attached on other diamond powders through C—C bonds. Diamond powders are connected together through the organic molecules.

22. A method of connecting silicon powders to substrates, the method comprising: exposing one or more silicon powders to one substrate. The silicon powders are with some or all non-silicon surface atoms desorbed. The substrate has been pre-functionalized with one or more organic molecules. The organic molecule has functionality to undergo cycloaddition reaction with the silicon powders. The functionality of the organic molecules can undergo cycloaddition reaction with the diamond powders. The functionality contains one C—C double bond with or without another double bond conjugated with the C—C double bond.

23. A method of connecting silicon powders, the method comprising: exposing two or more silicon powders to one or more bi-functional cross-linking molecules. The silicon powders are with some or all non-silicon surface atoms desorbed. The bi-functional cross-linking molecules have functionalities at both ends to undergo cycloaddition reaction with the silicon powders. Both functionalities of a bi-functional cross-linking molecule can undergo cycloaddition reaction with the silicon powders. Both functionalities of a bi-functional cross-linking molecule contain one C—C double bond with or without another double bond conjugated with the C—C double bond. One or more bi-functional cross-linking molecules covalently bonded to a silicon powder are in a state that, for a bi-functional cross-linking molecule, the two functionalities are covalently bonded to two different silicon powders.
